(19) United States
(12) Patent Application Publication
(10) Pub. No.: US 2010/0005517 A1
(43) Pub. Date: Jan. 7, 2010

(54) IPTV CONTENT SHARING IN IMS NETWORK

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/166,896

(22) Filed: Jul. 2, 2008

(51) Int. Cl. H04L 9/32

(52) U.S. Cl. 726/6

(57) ABSTRACT

A Content Sharing AS facilitates the sharing of IPTV content distribution sessions between users in an IMS network. A first user's request to share an ongoing IPTV session is routed to the Content Sharing AS, with a SIP URI of a second user with whom to share the content, identification of the desired content, and the Mcast address of the IPTV session. The Content Sharing AS joins the IGMP session group and sends the first user a SIP URI for the content and a unique authentication token. The first user sends the content URI and token to the second user, such as via a SMS message. The second user may then send an SIP INVITE message toward the URI, which the IMS system routes to the Content Sharing AS. The second user provides the authentication token, which the Content Sharing AS uses to authenticate the second user, and share the IPTV content.

### FIELD OF THE INVENTION

The present invention relates generally to communication networks, and in particular to a method of sharing an IPTV session in an IMS network.

### BACKGROUND

Internet Protocol Television (IPTV) describes various protocols whereby digital television service is delivered using Internet Protocol over a network infrastructure. One such network, increasingly deployed to provide 3G wireless communications services to mobile subscribers, is the IP Multimedia Subsystem (IMS). IMS uses known protocols, such as Session Initiation Protocol (SIP), to provide for easy integration with existing data networks, such as the Internet.

IPTV distribution to one or more individual users, such as via an IPTV Control Server and IPTV Terminal Function (ITF), is known in the art. Often, a user watching television content via an IPTV session may desire to share the program with a friend, who does not have access to the same content. The two users may then discuss the content they are both viewing (e.g., discuss plays in a sports game, or the like). Even if both users have access to IMS networks, there is currently no straightforward way to share an IPTV distribution.

### SUMMARY

According to one or more embodiments described herein, a Content Sharing Application Server (AS) facilitates the sharing of IPTV content distribution sessions between users. A first user's request to share an ongoing IPTV session is routed to the Content Sharing AS, with a SIP URI of a second user with whom to share the content, identification of the desired content, and the Mcast address of the IPTV session. The Content Sharing AS joints the IGMP session group and sends the first user a SIP URI for the content and a unique authentication token. The first user sends the SIP URI for the content and token to the second user, such as via a SMS message. The second user may then send a SIP INVITE message toward the URI, which the IMS system routes to the Content Sharing AS. The second user provides the authentication token, which the Content Sharing AS uses to authenticate the second user. If the authentication is successful, the Content Sharing AS then shares the IPTV content with the second user, at which point the first and second users are both viewing the same content.

### BRIEF DESCRIPTION OF THE DRAWINGS

FIG. 1 is a call flow diagram of a first user establishing an IPTV session and requesting that a second user share it.

FIG. 2 is a call flow diagram of a second user joining the first user's IPTV session.

FIG. 3 is a functional block diagram of a Content Sharing AS in an IMS network.

### DETAILED DESCRIPTION

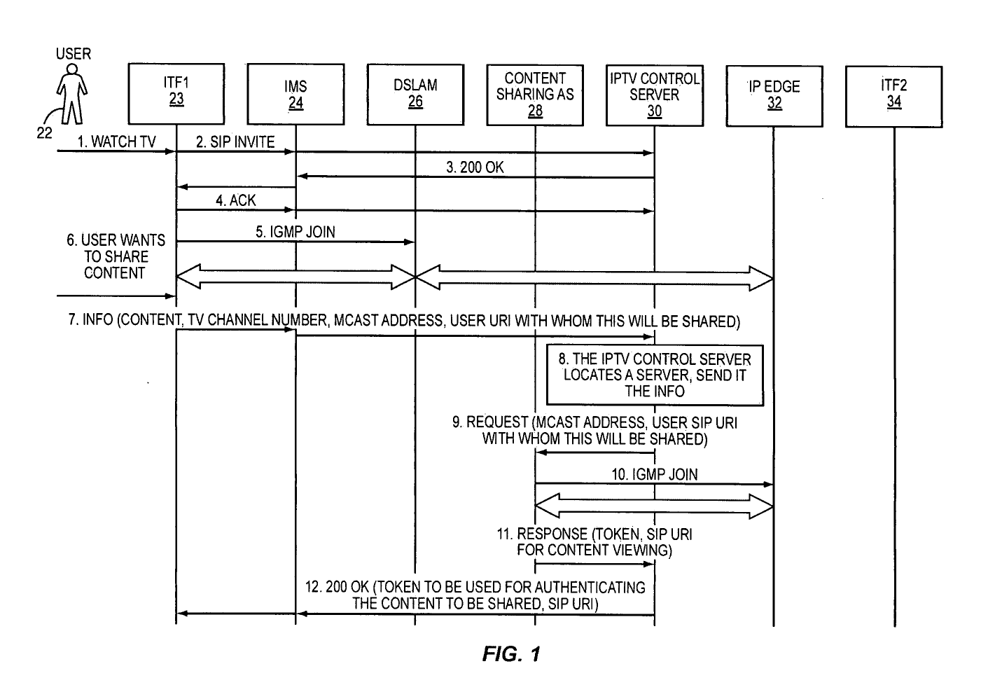

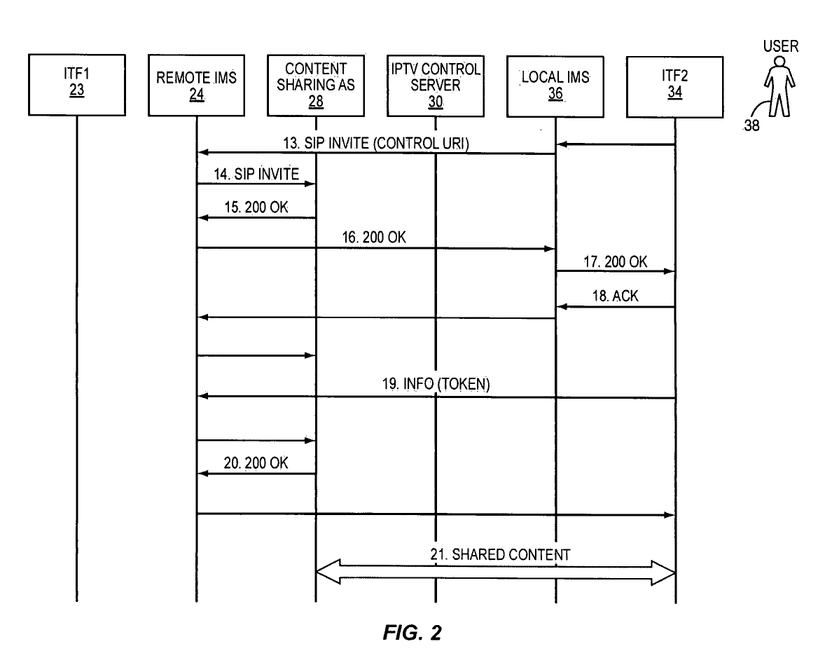

According to one or more embodiments of the present invention, a user engaged in an IPTV session may invite another user to join, or share, the content distribution session. One embodiment accomplishing this is described herein with respect to the call flow diagrams of FIGS. 1 and 2.

In FIG. 1, a first user 22 utilizes the IPTV Terminal Function (ITF) 23 of his User Equipment (UE) to request an IPTV content distribution session, at step 1. At step 2, the ITF 23 sends a SIP INVITE message into the IMS network 24, which routes the message to an IPTV Control Server 30. The IPTV Control Server 30, at step 3, returns a 200 OK acknowledgment, which the IMS network 24 forwards to the ITF 23. At step 4, the ITF 23 sends an ACK acknowledgment to the IMS 24, which forwards it to the IPTV Control Server 30. The ITF 23 also sends an Internet Group Management Protocol (IGMP) JOIN message to a Digital Subscriber Line Access Multiplexer (DSLAM) 26 at step 5. The ITF 23 then receives content from the IPTV Control Server 30, through the IP EDGE 32, via a DSLAM 26, and it renders for the first user 22.

The first user 22 may then decide to share the IPTV content distribution session with a second user 38 (FIG. 2). The first user 22 indicates such to the ITF 23 in his UE, at step 6. The ITF 23 sends an INFO message, at step 7, to the IPTV Control Server 30. The INFO message includes an identification of the content, such as the TV channel number, a Mcast address, and a SIP Uniform Resource Identifier (URI) associated with the second user 38. The SIP URI for the second user represents the user IMS public identity. At step 8, the IPTV Control Server 30 locates a Content Sharing Application Server (AS) 28, and sends to it a request including the Mcast address of the IPTV content distribution session and the SIP URI (IMS public identity) associated with the second user 38. The Content Sharing AS 28 joins the session by sending an IGMP JOIN message to the IP Edge 32 at step 10. This enables the Content Sharing AS 28 to receive the IPTV content. The Content Sharing AS 28 then sends a response to the IPTV Control Server 30, at step 11, including a unique authentication token and a SIP URI for accessing the IPTV content. The SIP URI for accessing the content represents an IMS Public Service Identity (PSI). A PSI is essentially a regular IMS identity, but it is intended for services and inherits all the properties of a regular IMS public identity, intended for real IMS users. At this point the content sharing AS establishes a binding between the PSI representing the content, the IMS public identity for the user, and the authentication token. There is preferably a timer associated with that binding to ensure its proper deletion for security reasons when the timer expires. The value of the timer is typically set based on operator policies. At step 12, the IPTV Control Server 30 sends a 200 OK message, including the authentication token and the SIP URL of the content, to the ITF 23.

The first user 22 (having the IMS SIP URI identity associated with the second user 38) then transmits the authentication token and the SIP URI of the content to the second user 38. This information may be sent in a Short Messaging Service (SMS) message, or via a SIP MESSAGE method.

FIG. 2 depicts the call flow for the second user 38 to join the IPTV content distribution session of the first user 20. At step 13, the second user sends a SIP INVITE message to the SIP URI (PSI) of the content (received from the first user 22), via his local IMS network 36, which forwards it to the remote IMS network 24. The remote IMS 24 forwards the SIP INVITE message to the Content Sharing AS 28, at step 14. The Content Sharing AS 28 responds with a 200 OK message at step 15, which the remote IMS 24 returns to the local IMS 36 at step 16. At step 17, the local IMS 36 forwards the 200 OK message to the ITF 34 in the UE of the second user 38.

The ITF 34 then sends an acknowledgment ACK to the Content Sharing AS 28, via the local IMS 36 and remote IMS 24, at step 18. Next, the ITF 34 sends to the Content Sharing AS 28 a SIP INFO message including the authentication token received from the first user 22, at step 19. The Content Sharing AS 28 authenticates the second user 28 using the authentication token, and responds with a 200 OK message at step 20. The Content Sharing AS 28 then shares the IPTV content with the ITF 34, at step 21. Those of skill in the art will recognize that, in a particular implementation, the IPTV content may be routed from the Content Sharing AS 28 through an IP EDGE and DSLAM to the ITF 34, the details of which are omitted for clarity. Both ITFs 23, 34 are now rendering the same IPTV content, and the two users 22, 38 may discuss the IPTV content in real time.

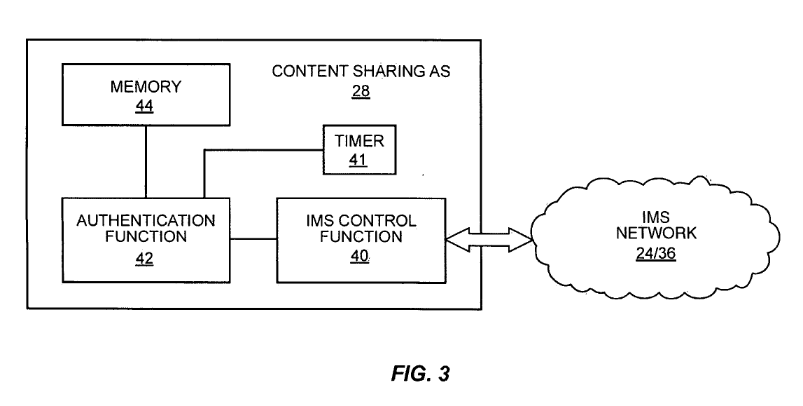

FIG. 3 is a functional block diagram of a representative Content Sharing AS 28, depicting functional modules germane to the present invention and omitting other functionality for clarity. The Content Sharing AS 28 includes an IMS Control Function 40 that processes SIP and other protocol messaging to and from the attached IMS network(s) 24, 36. The Content Sharing AS 28 also includes an Authentication Function 42 and memory 44. The Authentication Function 42 is operative to generate a unique authentication token which is sent to the first user 22, and to store the authentication token in memory 44. The Authentication Function 42 is further operative to authenticate the second user 38 by comparing the authentication token received from him to the one in memory 44. A timer function 41 provides a time-out, under the control of the IMS Control Function 40, to terminate the authentication binding, as described previously. The IMS Control Function 40 and the Authentication Function 42 may each be implemented as hard-wired or programmable hardware, software and module is executing on a microprocessor or digital signal processor (DSP), or any combination of hardware, firmware, and software known in the art or to be developed.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of sharing a content distribution session of a first user with a second user by a Content Sharing Application Server (AS) in an IP Multimedia Subsystem (IMS), comprising:
receiving a request to share content with the second user, the request including a Session Initiation Protocol (SIP) Uniform Resource Identifier (URI) associated with the second user;
sending a response including a SIP URI associated with the Content Sharing AS and an authentication token;
subsequently receiving a SIP INVITE from the second user;
receiving the authentication token from the second user;
authenticating the second user with the authentication token; and
sharing the IPTV session with the second user if authentication is successful.

2. The method of claim 1 wherein the content distribution session is an Internet Protocol Television (IPTV) session.

3. The method of claim 2 wherein the Content Sharing AS receives a request to share content from an IPTV Control Server in an Internet Group Management Protocol (IGMP) group of the first user.

4. The method of claim 3 wherein the Content Sharing AS receives the request to share content from the IPTV Control Server in response to the IPTV Control Server receiving a request to share content from the first user.

5. The method of claim 1 wherein sending a response including a SIP URI associated with the Content Sharing AS and an authentication token comprises sending the response to the first user.

6. The method of claim 5 wherein sending the response to the first user comprises sending the response to the first user via the IPTV Control Server.

7. The method of claim 1 further comprising establishing a binding between the SIP URI associated with the Content Sharing AS, the SIP URI associated with the second user, and the authentication token.

8. The method of claim 7 further comprising terminating the binding at the earlier of the termination of the shared content distribution session or the expiration of a predetermined duration.

9. A method sharing a content distribution session of a first user with a second user in an IP Multimedia Subsystem (IMS), comprising:
sending a share request to a content distribution server, the request including an identification of the content to be shared and a Session Initiation Protocol (SIP) Uniform Resource Identifier (URI) associated with the second user;
receiving a SIP URI associated with a Content Sharing Application Server (AS) and an authentication token; and
sending the SIP URI associated with the Content Sharing AS and the authentication token to the second user.

10. The method of claim 9 wherein the content distribution server is an Internet Protocol Television (IPTV) Control Server.

11. The method of claim 9 wherein sending the SIP URI associated with the Content Sharing AS and the authentication token to the second user comprises sending the URI and token via Short Messaging Service (SMS).

12. The method of claim 9 wherein sending the SIP URI associated with the Content Sharing AS and the authentication token to the second user comprises sending the URI and token via a SIP MESSAGE.

13. A method sharing a content distribution session of a first user by a second user in an IP Multimedia Subsystem (IMS), comprising:
receiving from the first user a Session Initiation Protocol (SIP) Uniform Resource Identifier (URI) associated with a Content Sharing Application Server (AS) and an authentication token;
sending a request to the Content Sharing AS to join the first user's content distribution session;
sending the authentication token to the Content Sharing AS; and
receiving content from the Content Sharing AS.

14. The method of claim 13 wherein the content distribution session comprises an Internet Protocol Television (IPTV) session.

15. A Content Sharing Application Server (AS) in an IP Multimedia Subsystem (IMS) comprising:
memory;
an IMS controller operative to process Session Initiation Protocol (SIP) messages and further operative to receive from a first user a SIP Uniform Resource Identifier (URI) associated with a second user and to receive from the second user a request to join a content distribution session; and
an authentication function operative to generate a unique authentication token, associate the token with the second user, store the token in the memory, send the token to the first user, and authenticate the second user by comparing the stored token to an authentication token subsequently received from the second user.

16. The Content Sharing AS of claim 15, wherein the content distribution session comprises an Internet Protocol Television (IPTV) session.

17. The Content Sharing AS of claim 15 further comprising a timer function operative to prompt termination of a binding between a SIP URI associated with the Content Sharing AS, the SIP URI associated with the second user, and the authentication token after a predetermined duration.
